(19) United States
(12) Patent Application Publication
(10) Pub. No.: US 2022/0317994 A1
(43) Pub. Date: Oct. 6, 2022

(54) OTA MASTER, UPDATE CONTROL METHOD, AND NON-TRANSITORY STORAGE MEDIUM

(71) Applicant: TOYOTA JIDOSHA KABUSHIKI KAISHA, Toyota-shi (JP)

(72) Inventor: Shoichi NAGAMITSU, Toyota-shi (JP)

(73) Assignee: TOYOTA JIDOSHA KABUSHIKI KAISHA, Toyota-shi (JP)

(21) Appl. No.: 17/689,171

(22) Filed: Mar. 8, 2022

(30) Foreign Application Priority Data
Mar. 30, 2021 (JP) 2021-057493

(51) Int. Cl. G06F 8/65; B60R 16/023

(52) U.S. Cl. CPC G06F 8/65; B60R 16/0231

(57) ABSTRACT

An OTA master includes one or more processors configured to: download, from a center, update data for software of an electronic control unit mounted in a vehicle; control a software update process of the electronic control unit by using the update data; determine whether power supply to the electronic control unit is interrupted during execution of the software update process; and transmit an update status of the software of the electronic control unit to the center when determining that the power supply is interrupted during the execution of the software update process.

### CROSS-REFERENCE TO RELATED APPLICATION

This application claims priority to Japanese Patent Application No. 2021-057493 filed on Mar. 30, 2021, incorporated herein by reference in its entirety.

### BACKGROUND

### 1. Technical Field

The present disclosure relates to an over-the-air (OTA) master, an update control method, and a non-transitory storage medium.

### 2. Description of Related Art

Vehicles include a plurality of electronic control units configured to control operations of the vehicles. The electronic control unit includes a processor, a transitory storage such as a random-access memory (RAM), and a non-volatile storage such as a flash read-only memory (ROM). The processor implements control functions of the electronic control unit by executing software stored in the storage. The software stored in each electronic control unit is rewritable. Updating to a newer version of the software enables improvement in the functions of the electronic control unit and addition of new vehicle control functions.

An over-the-air (OTA) technology is known as a technology for updating software of electronic control units. An in-vehicle communication device connected to an in-vehicle network is wirelessly connected to a communication network such as the Internet. A device that handles a software update process for the vehicle downloads the software through wireless communication from a center having a server function. The downloaded software is installed in the electronic control unit. In this manner, the software of the electronic control unit is updated or added.

The software update process using the OTA technology can be started by an OTA master by transmitting version information of the software of the electronic control unit to the center (confirming updates) via the in-vehicle communication device when power supply or ignition of the vehicle is ON (see, for example, Japanese Unexamined Patent Application Publication No. 2018-181377 (JP 2018-181377 A)). The OTA master is the device that handles the software update process for the vehicle. When the OTA master downloads update data from the center by OTA, the OTA master notifies a user about the update data by displaying the notification on a display device in the vehicle. When the OTA master receives acceptance from the user through an operation on an input device such as a button, the OTA master installs and activates the update data.

### SUMMARY

When the electronic control units need to be replaced due to malfunction or the like, cable terminals are removed from an in-vehicle battery before the replacement of the electronic control units to cut off power supply from the in-vehicle battery and power OFF the electronic control units in order to ensure work safety. When the electronic control units are powered OFF for replacement or the like during the software update process (download, installation, or activation) of the electronic control units, however, the software update process may be interrupted in an incomplete state in any electronic control unit to be updated. When the electronic control units are powered ON again, software update statuses may be different among the electronic control units.

The center that distributes the update data manages the status of the software update process based on a notification from the vehicle after the download of the update data is completed. When the electronic control units are powered OFF for replacement or the like, however, the notification from the vehicle may be interrupted. In this case, the software update status in the vehicle and the software update status managed by the center may mismatch each other.

The present disclosure provides an OTA master and the like that can suppress the mismatch between the software update status in the vehicle and the software update status managed by the center.

An OTA master according to a first aspect of the present disclosure includes one or more processors configured to: download, from a center, update data for software of an electronic control unit mounted in a vehicle; control a software update process of the electronic control unit by using the update data; determine whether power supply to the electronic control unit is interrupted during execution of the software update process; and transmit an update status of the software of the electronic control unit to the center when determining that the power supply is interrupted during the execution of the software update process.

A update control method according to a second aspect of the present disclosure is to be executed by an OTA master including one or more processors, a memory, and a storage device. The update control method includes: downloading, from a center, update data for software of an electronic control unit mounted in a vehicle; controlling a software update process of the electronic control unit by using the update data; determining whether power supply to the electronic control unit is interrupted during execution of the software update process; and transmitting an update status of the software of the electronic control unit to the center when determining that the power supply is interrupted during the execution of the software update process.

A non-transitory storage medium according to a third aspect of the present disclosure stores an update control program that is executable by a computer of an OTA master including one or more processors, a memory, and a storage device and that causes the computer to perform functions including: downloading, from a center, update data for software of an electronic control unit mounted in a vehicle; controlling a software update process of the electronic control unit by using the update data; determining whether power supply to the electronic control unit is interrupted during execution of the software update process; and transmitting an update status of the software of the electronic control unit to the center when determining that the power supply is interrupted during the execution of the software update process.

With the OTA master, the update control method, and the non-transitory storage medium of the present disclosure, it is possible to suppress the mismatch between the software update status in the vehicle and the software update status managed by the center.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an overall configuration of a network system according to an embodiment;

FIG. 2 is a block diagram illustrating a schematic configuration of a center;

FIG. 3 is a functional block diagram of the center;

FIG. 4 is a block diagram illustrating a schematic configuration of an OTA master;

FIG. 5 is a functional block diagram of the OTA master;

FIG. 6 is a flowchart of a software update control process to be executed by the OTA master; and

FIG. 7 is a flowchart of a process of Step S608 of FIG. 6.

### DETAILED DESCRIPTION OF EMBODIMENTS

In a network system for updating a program of an electronic control unit according to the present disclosure, when power is turned OFF due to interruption of power supply or the like during a software update process and then turned ON again, an OTA master acquires a software update status and notifies a center about the software update status. As a result, the software update status in a vehicle can be reflected in management information in the center. An embodiment of the present disclosure will be described below in detail with reference to the drawings.

### EMBODIMENT

### System Configuration

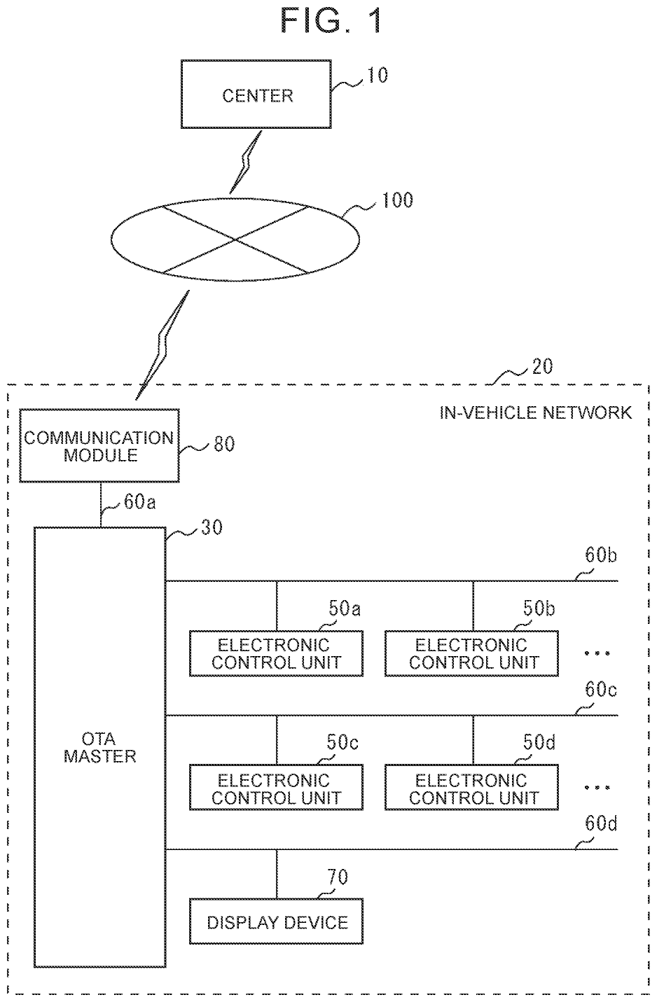

FIG. 1 is a block diagram illustrating an overall configuration of a network system according to an embodiment of the present disclosure. The network system illustrated in FIG. 1 is a system for updating software of a plurality of electronic control units 50a to 50d mounted on a vehicle, and includes a center 10 outside the vehicle and an in-vehicle network 20 constructed inside the vehicle.

### (1) Center

The center 10 is communicable, via a network 100, with an OTA master 30 described later in the in-vehicle network 20 to transmit update data of the electronic control units 50a to 50d and receive a notification about progress of a software update process, thereby managing software update of the electronic control units 50a to 50d connected to the OTA master 30. The center 10 has functions of a so-called server.

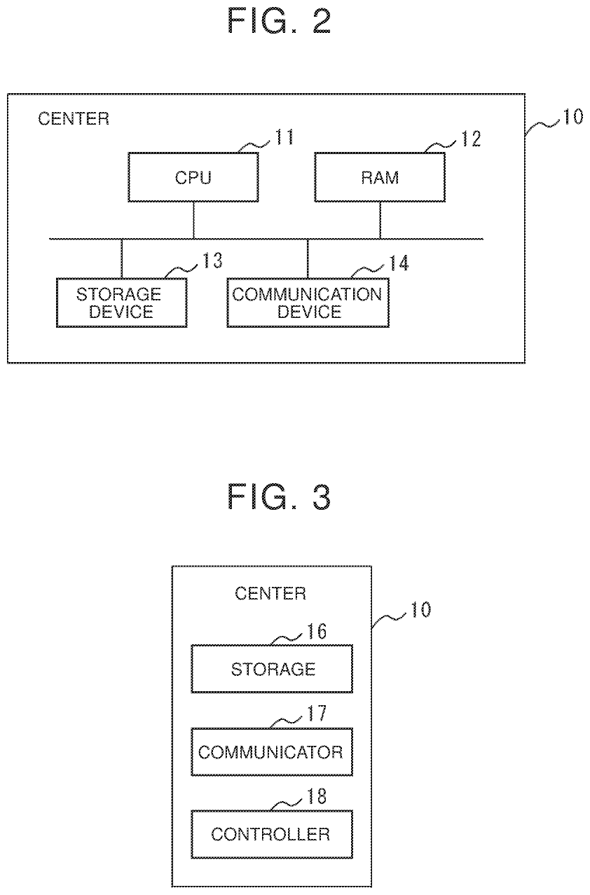

FIG. 2 is a block diagram illustrating a schematic configuration of the center 10 in FIG. 1. As illustrated in FIG. 2, the center 10 includes a central processing unit (CPU) 11, a random-access memory (RAM) 12, a storage device 13, and a communication device 14. The storage device 13 includes a readable/writable storage medium such as a hard disk drive (HDD) or a solid state drive (SSD), and stores, for example, programs for executing software update management, information to be used for the software update management, and update data of each electronic control unit. In the center 10, the CPU 11 executes the program read from the storage device 13 by using the RAM 12 as a work area to execute a predetermined process related to software update. The number of the CPU 11 is not limited to one. The communication device 14 communicates with the OTA master 30 via the network 100.

FIG. 3 is a functional block diagram of the center 10 illustrated in FIG. 2. The center 10 illustrated in FIG. 3 includes a storage 16, a communicator 17, and a controller 18. The storage 16 is implemented by the storage device 13 illustrated in FIG. 2. The communicator 17 and the controller 18 are implemented by the CPU 11 illustrated in FIG. 2 executing the programs stored in the storage device 13 by using the RAM 12.

The storage 16 stores information related to the software update process of one or more electronic control units mounted on the vehicle. As the information related to the software update process, the storage 16 stores at least update management information in which information indicating software available for the electronic control units 50a to 50d is associated with vehicle identification information (vehicle ID) for identifying the vehicle, and software update data of the electronic control units 50a to 50d. Examples of the information indicating software available for the electronic control units 50a to 50d include a combination of pieces of latest version information of software products of the electronic control units 50a to 50d. As the information related to the software update process, the storage 16 also stores an update status that is a status of the software update being executed in the vehicle.

The communicator 17 is capable of receiving a software update confirmation request from the OTA master 30. For example, the update confirmation request is information to be transmitted from the OTA master 30 to the center 10 at a timing when power supply or ignition is turned ON (hereinafter referred to as “powered ON”) in the vehicle, and is information for requesting the center 10 to confirm whether there is update data of the electronic control units 50a to 50d based on vehicle configuration information described later. In response to the update confirmation request received from the OTA master 30, the communicator 17 transmits information indicating the presence or absence of update data to the OTA master 30. The communicator 17 is also capable of receiving a distribution package transmission request (download request) from the OTA master 30. In response to reception of the distribution package download request, the communicator 17 transmits, to the OTA master 30, a distribution package including the update data of the software of the electronic control units 50a to 50d that is generated by the controller 18 described later.

When the communicator 17 receives the update confirmation request from the OTA master 30, the controller 18 determines whether there is software update data for the electronic control units 50a to 50d mounted on the vehicle identified by the vehicle ID included in the update confirmation request based on the update management information stored in the storage 16. A result of the determination made by the controller 18 as to whether there is update data is transmitted to the OTA master 30 by the communicator 17. When determination is made that there is software update data for the electronic control units 50a to 50d and the distribution package download request is received from the OTA master 30, the controller 18 generates a distribution package including the corresponding update data stored in the storage 16.

### (2) In-Vehicle Network

The in-vehicle network 20 includes the OTA master 30, the electronic control units 50a to 50d, a display device 70, and a communication module 80. The OTA master 30 and the communication module 80 are connected via a bus 60a. The OTA master 30 and the electronic control units 50a and 50b are connected via a bus 60b. The OTA master 30 and the electronic control units 50c and 50d are connected via a bus 60c. The OTA master 30 and the display device 70 are connected via a bus 60d.

The OTA master 30 can wirelessly communicate with the center 10 via the bus 60a, the communication module 80, and the network 100. The OTA master 30 can also communicate with the electronic control units 50a to 50d and the display device 70 by wire via the buses 60b to 60d. The OTA master 30 is a device having a function of managing an OTA status, controlling a software update sequence, and updating software of an electronic control unit to be updated (hereinafter referred to as “target electronic control unit”). The OTA master 30 controls the software update of the target electronic control unit among the electronic control units 50a to 50d based on, for example, the update data acquired from the center 10 through the communication. The OTA master 30 may also be referred to as “central gateway (CGW)”.

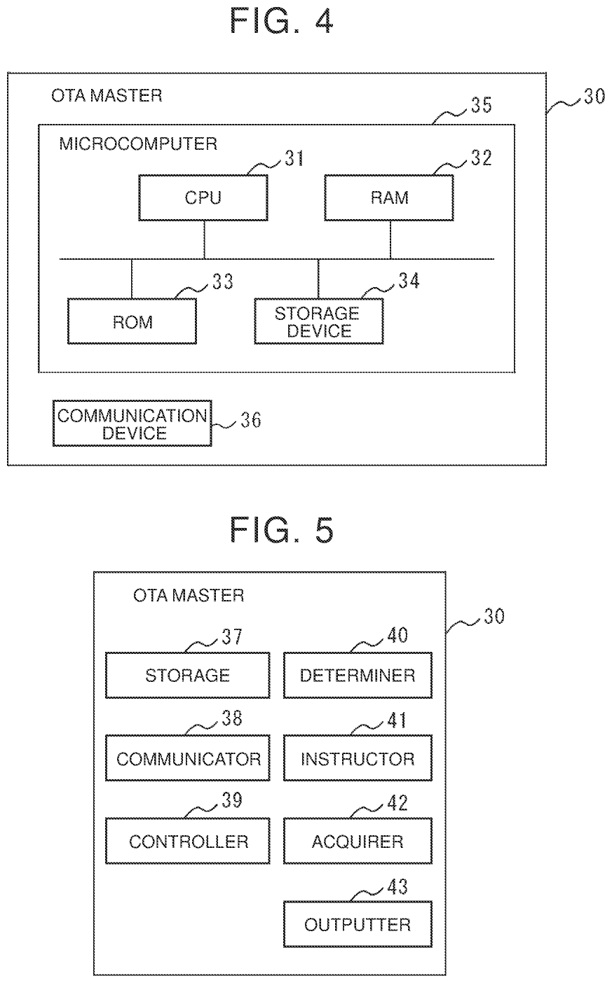

FIG. 4 is a block diagram illustrating a schematic configuration of the OTA master 30 in FIG. 1. As illustrated in FIG. 4, the OTA master 30 includes a CPU 31, a RAM 32, a read-only memory (ROM) 33, a storage device 34, and a communication device 36. The CPU 31, the RAM 32, the ROM 33, and the storage device 34 constitute a microcomputer 35. In the OTA master 30, the CPU 31 executes a program read from the ROM 33 by using the RAM 32 as a work area to execute a predetermined process related to software update. The number of the CPU 31 is not limited to one. The communication device 36 communicates with the communication module 80, the electronic control units 50a to 50d, and the display device 70 via the buses 60a to 60d illustrated in FIG. 1.

FIG. 5 is a functional block diagram of the OTA master 30 illustrated in FIG. 4. The OTA master 30 illustrated in FIG. 5 includes a storage 37, a communicator 38, a controller 39, a determiner 40, an instructor 41, an acquirer 42, and an outputter 43. The storage 37 is implemented by the storage device 34 illustrated in FIG. 4. The communicator 38, the controller 39, the determiner 40, the instructor 41, the acquirer 42, and the outputter 43 are implemented by the CPU 31 illustrated in FIG. 4 executing programs stored in the ROM 33 by using the RAM 32.

The storage 37 stores a program for executing software update of the electronic control units 50a to 50d (control program for the OTA master 30), various types of data to be used when executing the software update, and software update data downloaded from the center 10. The storage 37 also stores a log related to the software update process of the electronic control units 50a to 50d and output by the outputter 43 described later.

The communicator 38 transmits and receives data, information, requests, and the like to and from the center 10. For example, the communicator 38 transmits a software update confirmation request to the center 10 when the vehicle is powered ON. For example, the update confirmation request includes the vehicle ID for identifying the vehicle, and information on software versions of the electronic control units 50a to 50d connected to the in-vehicle network 20. The vehicle ID and the information on the software versions of the electronic control units 50a to 50d are used to determine whether there is software update data for the electronic control units 50a to 50d by making comparison with the latest software versions held in the center 10 for each vehicle ID. The communicator 38 also receives a notification about the presence or absence of update data from the center 10 as a response to the update confirmation request. When there is software update data for the electronic control units 50a to 50d, the communicator 38 functions as a receiver configured to transmit a download request for a distribution package including the update data to the center 10 and receive (download) the distribution package transmitted from the center 10. The communicator 38 also functions as a first transmitter configured to transmit, to the center 10, software update statuses of the electronic control units 50a to 50d acquired by the acquirer 42 described later. When the power is turned OFF due to interruption of the power supply or the like during the software update process (hereinafter referred to as “powered OFF”), the communicator 38 can function as a second transmitter configured to transmit a download request or a download restart request for the distribution package to the center 10.

The controller 39 determines whether there is software update data for the electronic control units 50a to 50d based on the response to the update confirmation request that is received from the center 10 by the communicator 38. The controller 39 also verifies authenticity of the distribution package received (downloaded) from the center 10 by the communicator 38 and stored in the storage 37. The controller 39 also controls the software update process (installation or activation) of the electronic control units 50a to 50d by using the update data received (downloaded) from the center 10. Specifically, the controller 39 transfers one or more pieces of update data downloaded in the distribution package to the target electronic control unit, and causes the target electronic control unit to install update software based on the update data. After the installation is completed, the controller 39 instructs the target electronic control unit to activate, that is, enable the installed update software. When the power is turned OFF due to the interruption of the power supply or the like after the download of the update data is completed, the controller 39 can execute the software update process again by using the downloaded update data.

The determiner 40 determines whether the power is turned OFF due to the interruption of the power supply or the like during the execution of the software update process (download, installation, or activation). For example, the determination of whether the power supply is interrupted can be made based on a predetermined event such as an abrupt drop of a voltage of a power supply line connected to an in-vehicle battery or an abnormal previous termination of the power supply to the electronic control units in which the OTA master 30 is implemented.

When the determiner 40 determines that the power is turned OFF due to the interruption of the power supply or the like during the execution of the software update process, the instructor 41 transmits a reset signal to the target electronic control unit at a timing when the power is recovered and turned ON again. For example, the reset signal is an instruction for the target electronic control unit to execute a rollback process for software whose update is not normally completed, and to transmit a software update status (software update completion, rollback process completion, or an error (impossibility of rollback)) to the OTA master 30.

The acquirer 42 acquires information related to the software update status transmitted by the target electronic control unit based on the reset signal.

The outputter 43 outputs, to the log, the information related to the software update status of the target electronic control unit and acquired by the acquirer 42. For example, regarding the target electronic control unit whose software update process is normally completed even though the power is turned OFF due to the interruption of the power supply or the like during the execution of the software update process, the outputter 43 outputs a log indicating that the update is completed through an irregular software update process.

The electronic control units 50a to 50d are devices (ECUs) configured to control operations of individual parts of the vehicle. Although the four electronic control units 50a to 50d are exemplified in FIG. 1, the number of electronic control units is not particularly limited. The number of buses connecting the electronic control units to the OTA master 30 is not particularly limited as well.

The display device 70 is a human-machine interface (HMI) to be used for various types of display such as display of information indicating that there is update data during the software update process of the electronic control units 50a to 50d, display of an acceptance request screen for requesting acceptance of the user or administrator of the vehicle for the software update, and display of a result of the software update. A typical example of the display device 70 is a display device of a car navigation system. The display device 70 is not particularly limited as long as the display device 70 can display information necessary for the program update process. An electronic control unit may further be connected to the bus 60d illustrated in FIG. 1 in addition to the display device 70.

The communication module 80 is a unit having a function of controlling communication between the center 10 and the vehicle, and is a communication device for connecting the in-vehicle network 20 to the center 10. The communication module 80 is wirelessly connected to the center 10 via the network 100 so that the OTA master 30 authenticates the vehicle and downloads update data. The communication module 80 may be included in the OTA master 30.

### Overview of Software Update Process

For example, the OTA master 30 transmits a software update confirmation request to the center 10 when the vehicle is powered ON. The update confirmation request includes the vehicle ID for identifying the vehicle, and vehicle configuration information related to statuses of the electronic control units (system configuration), such as hardware and software versions of the electronic control units 50a to 50d connected to the in-vehicle network 20. The vehicle configuration information can be created by acquiring identification numbers of the electronic control units (ECU_IDs) and identification numbers of the software versions of the electronic control units (ECU_Software_IDs) from the electronic control units 50a to 50d connected to the in-vehicle network 20. The vehicle ID and the software versions of the electronic control units 50a to 50d are used to determine whether there is software update data for the electronic control units 50a to 50d by making comparison with the latest software versions held in the center 10 for each vehicle ID. The OTA master 30 receives a notification about the presence or absence of update data from the center 10 as a response to the update confirmation request. When there is software update data for the electronic control units 50a to 50d, the OTA master 30 transmits a distribution package download request to the center 10, and receives a distribution package transmitted from the center 10. The distribution package may include, in addition to the update data, verification data for verifying the authenticity of the update data, the number of pieces of the update data, the order of installation, the order of activation, type information, and various types of control information to be used during software update.

The OTA master 30 determines whether there is software update data for the electronic control units 50a to 50d based on the response to the update confirmation request that is received from the center 10. The OTA master 30 verifies the authenticity of the distribution package received from the center 10 and stored in the storage device 34. The OTA master 30 transfers one or more pieces of update data downloaded in the distribution package to the target electronic control unit, and causes the target electronic control unit to install the updated version of software based on the update data. After the installation is completed, the OTA master 30 instructs the target electronic control unit to enable the installed updated version of software.

In an acceptance request process, the OTA master 30 causes an output device to output a notification that acceptance is required for software update, and a notification that prompts the user to input acceptance for the software update. Examples of the output device include the display device 70 provided in the in-vehicle network 20 and an audio output device that provides notifications by voice or sound. For example, when the display device 70 is used as the output device in the acceptance request process, the OTA master 30 is capable of causing the display device 70 to display an acceptance request screen for requesting acceptance for the software update, and to display a notification that prompts the user or administrator to perform a specific input operation such as pressing of an acceptance button when accepting the software update. In the acceptance request process, the OTA master 30 is capable of causing the display device 70 to display texts, icons, or the like for notifying that there is software update data for the electronic control units 50a to 50d, and to display restrictions during the execution of the software update process. In response to reception of the input of acceptance from the user or administrator, the OTA master 30 executes a control process for the installation and activation to update the software of the target electronic control unit.

When a non-volatile memory of the electronic control unit is a single-bank memory having one storage area for storing the program, the installation and activation are executed in succession. Therefore, the acceptance request process for the software update is executed before the installation. When the non-volatile memory of the electronic control unit is a dual-bank memory having two storage areas for storing the program, the acceptance request process for the software update is executed at least after the installation and before the activation. When the non-volatile memory of the electronic control unit is the dual bank memory, the acceptance request process for the software update before the installation may be executed or omitted.

The software update process includes a phase in which the OTA master 30 downloads update data from the center 10 (download phase), a phase in which the OTA master 30 transfers the downloaded update data to the target electronic control unit and installs the update data (the updated version of software) in the storage area of the target electronic control unit (installation phase), and a phase in which the target electronic control unit enables the installed updated version of software (activation phase).

Download is a process in which the OTA master 30 receives the software update data for the electronic control units 50a to 50d that is transmitted from the center 10 in the form of the distribution package and stores the update data in the storage device 34. The download phase includes not only the execution of download, but also control of a series of processes related to the download, such as determination of whether the download can be executed, request for acceptance of the user or administrator of the vehicle for the download, and verification of the updated data.

The update data transmitted from the center 10 to the OTA master 30 may include update software for the electronic control units 50a to 50d, compressed data of the update software, or divided data of the update software or the compressed data. The update data may include an ECU_ID (or serial number) of the target electronic control unit and an ECU_Software_ID of the electronic control unit before update. The update data is downloaded as the distribution package. The distribution package includes update data for one or more electronic control units.

Installation is a process in which the OTA master 30 writes the update software (updated version program) to the target electronic control unit based on the update data downloaded from the center 10. The installation phase includes not only the execution of installation, but also control of a series of processes related to the installation, such as determination of whether the installation can be executed, request for acceptance of the user or administrator of the vehicle for the installation, transfer of the update data, and verification of the update software.

When the update data includes the update software, the OTA master 30 transfers the update data (update software) to the target electronic control unit in the installation phase. When the update data includes compressed data, difference data, or divided data of the update software, the OTA master 30 may transfer the update data to the target electronic control unit and the target electronic control unit may generate the update software from the update data. Alternatively, the OTA master 30 may generate the update software from the update data and then transfer the update software to the target electronic control unit. The update software can be generated by decompressing the compressed data or assembling (integrating) the difference data or the divided data.

The update software can be installed by the target electronic control unit based on an installation request (or instruction) from the OTA master 30 (or the center 10). Alternatively, the target electronic control unit that has received the update data may autonomously execute the installation without receiving an explicit instruction from the OTA master 30.

Activation is a process in which the target electronic control unit enables (activates) the installed update software. The activation phase includes not only the execution of activation, but also a series of controls related to the activation, such as determination of whether the activation can be executed, request for acceptance of the user or administrator of the vehicle for the activation, and verification of an execution result.

The update software can be activated by the target electronic control unit based on an activation request (or instruction) from the OTA master 30 (or the center 10). Alternatively, the target electronic control unit that has received the update data may autonomously execute the activation after completion of the installation without receiving an explicit instruction from the OTA master 30.

The software update process can be executed successively or in parallel for the electronic control units.

The “software update process” herein includes not only a process of successively executing all of the download, installation, and activation, but also a process of executing only a part of the download, installation, and activation.

### Processes

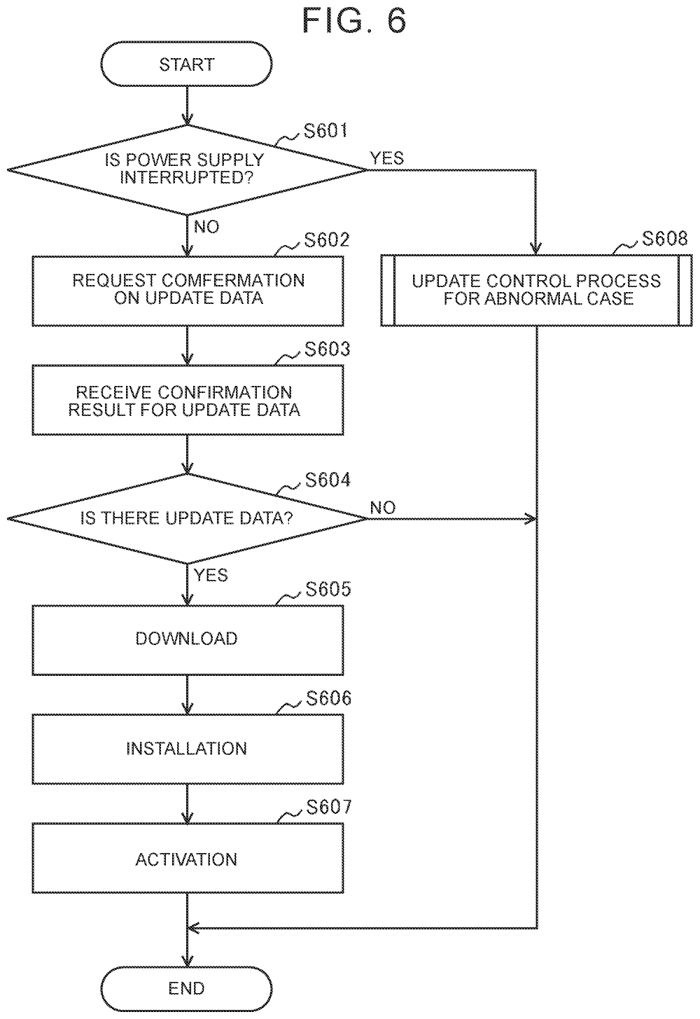

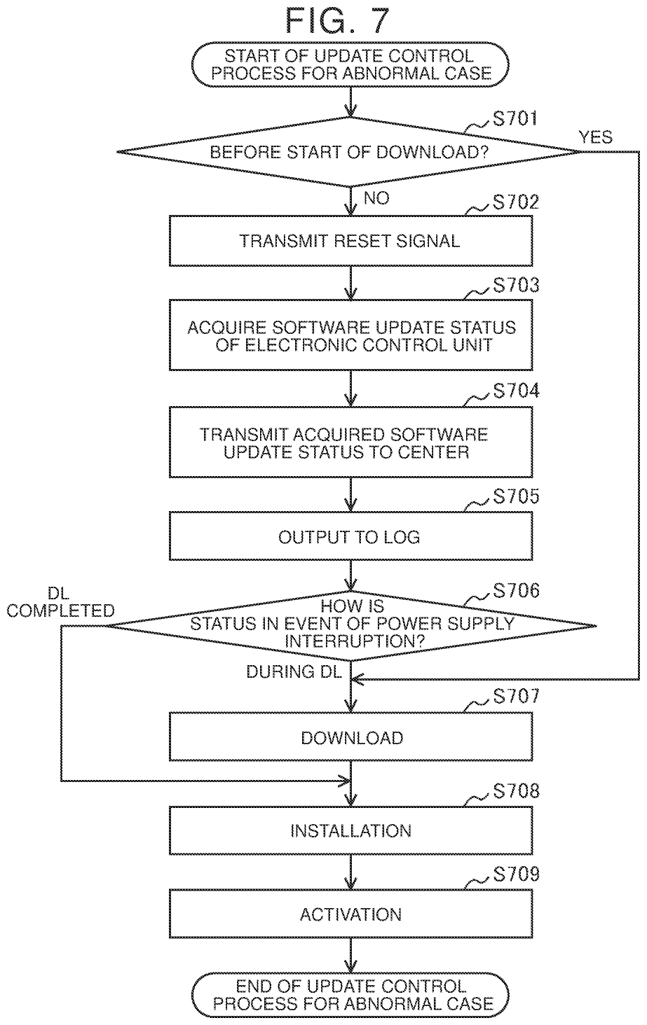

Next, processes to be executed in the network system according to the present embodiment will be described with reference to FIGS. 6 and 7 as well.

FIG. 6 is a flowchart illustrating a procedure of a software update control process to be executed by the OTA master 30. For example, the software update control process illustrated in FIG. 6 is executed when the vehicle is powered ON.

### Step S601

The determiner 40 of the OTA master 30 determines whether the power supply to the electronic control units 50a to 50d is interrupted during the execution of the software update control process. Specifically, determination is made as to whether the power supply is previously turned OFF due to the interruption of the power supply. When determination is made that the power supply is not interrupted (NO in Step S601), the process proceeds to Step S602 to execute the normal software update process. When determination is made that the power supply is interrupted (YES in Step S601), the process proceeds to Step S608 to execute the software update control process for an abnormal case.

### Step S602

The communicator 38 of the OTA master 30 transmits, to the center 10, a confirmation request as to whether there is software update data for the electronic control units 50a to 50d. This confirmation request includes information on a combination of the vehicle ID and the software versions of the electronic control units 50a to 50d. When the confirmation request is transmitted to the center 10, the process proceeds to Step S603.

### Step S603

The communicator 38 of the OTA master 30 receives, from the center 10, a confirmation result for the update data confirmation request. When the confirmation result is received, the process proceeds to Step S604.

### Step S604

The controller 39 of the OTA master 30 determines whether there is software update data for at least one of the electronic control units 50a to 50d based on the confirmation result for the update data confirmation request that is received by the communicator 38. When there is at least one piece of software update data (YES in Step S604), the process proceeds to Step S605. When there is no software update data (NO in Step S604), the software update control process is terminated.

### Step S605

The controller 39 of the OTA master 30 downloads the update data. More specifically, the communicator 38 of the OTA master 30 transmits a distribution package download request to the center 10, and receives a distribution package transmitted in response to the download request. The communicator 38 stores the received distribution package in the storage 37 of the OTA master 30. The controller 39 verifies the authenticity of the update data included in the received distribution package. In Step S605, the controller 39 may determine, before the download, whether the download can be executed, and the communicator 38 may transmit, after the download is completed, a notification to the center 10 about the completion of the download. When the update data is downloaded, the process proceeds to Step S606.

### Step S606

The controller 39 of the OTA master 30 executes an installation process for the target electronic control unit. More specifically, the controller 39 transfers the update data in the distribution package to the target electronic control unit, and instructs the target electronic control unit to install the update data (the updated version of software). The target electronic control unit writes the update data (the updated version of software) received from the OTA master 30 to the data storage area. When the installation process is executed, the process proceeds to Step S607.

### Step S607

The controller 39 of the OTA master 30 executes an activation process for the target electronic control unit. More specifically, the controller 39 instructs the target electronic control unit that has the data storage area to which the update data (the updated version of software) has been written to activate the updated version of software. The target electronic control unit is restarted and executes the updated software when a specific input operation such as powering OFF is performed. When the activation process is executed, the software update control process is terminated.

### Step S608

The OTA master 30 executes the software update process when the power is turned ON again after the power is turned OFF due to the interruption of the power supply (software update control process for the abnormal case). When the software update control process for the abnormal case is executed, the software update control process is terminated.

The software update process for the abnormal case in Step S608 of FIG. 6 will be described with reference to FIG. 7. FIG. 7 is a flowchart illustrating a procedure of the software update control process to be executed by the OTA master 30 in Step S608 of FIG. 6 when the power supply is interrupted in the series of processes.

### Step S701

The controller 39 of the OTA master 30 determines whether the download of the update data has not been started yet. That is, determination is made as to whether the download of the update data has not been started (the software update has not been started) at the timing when the power supply is interrupted. When the power is turned OFF due to the interruption of the power supply but the download of the update data has not started, the software update statuses do not differ among the target electronic control units, and the software update status in the vehicle matches the software update status managed by the center 10. When the download of the update data has not been started yet (YES in Step S701), the process proceeds to Step S707. When the download of the update data has been started (NO in Step S701), the process proceeds to Step S702.

### Step S702

The instructor 41 of the OTA master 30 transmits a reset signal to the target electronic control unit. The reset signal is an instruction for the target electronic control unit to execute a rollback process for software whose update is not normally completed, and to transmit the software update status. When the reset signal is transmitted, the process proceeds to Step S703.

### Step S703

The acquirer 42 of the OTA master 30 acquires the software update status from the target electronic control unit that has received the reset signal. When the software update status is acquired, the process proceeds to Step S704.

### Step S704

The communicator 38 of the OTA master 30 transmits, to the center 10, information related to the software update status of the electronic control unit and acquired by the acquirer 42. When the information related to the software update status is transmitted to the center 10, the process proceeds to Step S705.

### Step S705

The outputter 43 of the OTA master 30 outputs, to the log, the information related to the software update status of the target electronic control unit and acquired by the acquirer 42. This log is stored in the storage 37 of the OTA master 30. When the information related to the software update status is output to the log, the process proceeds to Step S706.

### Step S706

The controller 39 of the OTA master 30 determines how the software update status is in the event of interruption of the power supply. When the software update status in the event of interruption of the power supply is downloading of the update data (“During DL” in Step S706), the process proceeds to Step S707. When the software update status in the event of interruption of the power supply is after completion of the download of the update data (“DL completed” in Step S706), the process proceeds to Step S708.

### Step S707

The controller 39 of the OTA master 30 determines that the download of the update data is incomplete, and downloads the update data. More specifically, the communicator 38 of the OTA master 30 transmits a download request or a download restart request for the distribution package to the center 10, and receives the distribution package transmitted in response to the download request or the download restart request. The communicator 38 stores the received distribution package in the storage 37 of the OTA master 30. The controller 39 verifies the authenticity of the update data included in the received distribution package. When the update data is downloaded, the process proceeds to Step S708.

### Step S708

The controller 39 of the OTA master 30 executes the installation process for the target electronic control unit. More specifically, the controller 39 transfers, to the target electronic control unit, the update data in the initially downloaded or re-downloaded distribution package, and instructs the target electronic control unit to install the update data (the updated version of software). The target electronic control unit writes the update data (the updated version of software) received from the OTA master 30 to the data storage area. When the installation process is executed, the process proceeds to Step S709.

### Step S709

The controller 39 of the OTA master 30 executes the activation process for the target electronic control unit. More specifically, the controller 39 instructs the target electronic control unit that has written the update data to the data storage area to activate the updated version of software. The target electronic control unit is restarted and executes the updated software when a specific input operation such as powering OFF is performed. When the activation process is executed, the software update control process for the abnormal case is terminated.

In the software update control process for the abnormal case (FIG. 7) to be executed when the power is turned OFF due to the interruption of the power supply, description is given of the example in which the download, installation, and activation processes are restarted in Steps S707 to S709 after the power is recovered. Instead of restarting the processes (Steps S707 to S709) immediately after the power is recovered, the processes may be restarted by the software update control process for the normal case (FIG. 6) in response to a next normal operation (such as powering ON). At this time, the processes may be restarted only when the vehicle configuration information is normal (for example, when the rollback to the normal state is executed). The restart may be executed after obtaining the acceptance of the user or administrator via the display device 70. Specifically, when the installation process is interrupted due to the power supply interruption, the processes are proceeded after the rollback is executed to a state before the installation process and then the user or administrator is asked to confirm that the installation process will be started. Thus, it is possible to give a notification and a permission request about the installation process while ensuring safety, and to restart the software update process at a timing intended by the user or administrator.

### Effects

As described above, the OTA master 30 according to the embodiment of the present disclosure acquires the software update status and notifies the center 10 about the software update status when the power is turned OFF due to the interruption of the power supply or the like during the software update process and then turned ON again. As a result, the software update status in the vehicle can be reflected in the management information in the center 10.

When the software update is normally completed even though the power is turned OFF due to the interruption of the power supply or the like during the software update process, the OTA master 30 according to the present embodiment records a log indicating that event. Thus, it is possible to grasp how the software is updated when the software update process needs to be investigated.

The OTA master 30 according to the present embodiment can restore the progress of the software update process to a state before the interruption of the power supply by automatically re-downloading or resuming downloading the update data.

The OTA master 30 according to the present embodiment can bring the software of the electronic control units 50a to 50d into a consistent and latest state by re-executing the software update process using the update data.

Although the embodiment of the technology of the present disclosure has been described above, the present disclosure can be understood not only as the OTA master but also as, for example, an update control method to be executed by an OTA master including a processor, a memory, and a storage device, an update control program, or a non-transitory computer-readable storage medium storing the update control program.

The technology of the present disclosure can be used in a network system for updating software of an electronic control unit.

What is claimed is:

1. An over-the-air (OTA) master comprising one or more processors configured to:
download, from a center, update data for software of an electronic control unit mounted in a vehicle;
control a software update process of the electronic control unit by using the update data;
determine whether power supply to the electronic control unit is interrupted during execution of the software update process; and
transmit an update status of the software of the electronic control unit to the center when determining that the power supply is interrupted during the execution of the software update process.

2. The OTA master according to claim 1, wherein the one or more processors are configured to acquire the update status of the software from the electronic control unit when determining that the power supply is interrupted during the execution of the software update process.

3. The OTA master according to claim 2 wherein the one or more processors are configured to instruct the electronic control unit to reset the software update process after recovery of the power supply when determining that the power supply is interrupted during the execution of the software update process.

4. The OTA master according to claim 2, wherein the one or more processors are configured to, when acquiring information indicating that the software update process is normally completed as the update status of the software of the electronic control unit, output a log indicating that the software of the electronic control unit is updated by a software update process different from a normal software update.

5. The OTA master according to claim 1, wherein the one or more processors are configured to transmit a download request or a download restart request for the update data to the center when determining that the power supply is interrupted during download of the update data.

6. The OTA master according to claim 1, wherein the one or more processors are configured to start the software update process when determining that the power supply is interrupted after download of the update data and after start of the software update process.

7. An update control method to be executed by an over-the-air (OTA) master including one or more processors, a memory, and a storage device, the update control method comprising:
downloading, from a center, update data for software of an electronic control unit mounted in a vehicle;
controlling a software update process of the electronic control unit by using the update data;
determining whether power supply to the electronic control unit is interrupted during execution of the software update process; and
transmitting an update status of the software of the electronic control unit to the center when determining that the power supply is interrupted during the execution of the software update process.

8. A non-transitory storage medium storing an update control program that is executable by a computer of an over-the-air (OTA) master including one or more processors, a memory, and a storage device and that causes the computer to perform functions comprising:
downloading, from a center, update data for software of an electronic control unit mounted in a vehicle;
controlling a software update process of the electronic control unit by using the update data;
determining whether power supply to the electronic control unit is interrupted during execution of the software update process; and
transmitting an update status of the software of the electronic control unit to the center when determining that the power supply is interrupted during the execution of the software update process.
